(19) United States
(12) Patent Application Publication
(10) Pub. No.: US 2026/0213950 A1
(43) Pub. Date: Jul. 23, 2026

(54) ATTESTED DECISION PROVENANCE SYSTEM FOR HARDWARE-ISOLATED AI EXECUTION

(71) Applicant: George William Bickerstaff, III, Greenwich, CT (US)

(72) Inventor: George William Bickerstaff, III, Greenwich, CT (US)

(21) Appl. No.: 19/567,239

(22) Filed: Mar. 15, 2026

(51) Int. Cl. H04L 9/32; G06F 21/62; H04L 9/08

(52) U.S. Cl. CPC H04L 9/3236; G06F 21/6245; H04L 9/0852; H04L 9/3213; H04L 9/3247

(57) ABSTRACT

A system generates attested decision provenance records for artificial intelligence models. The AI model executes within a hardware-isolated enclave that prevents access or modification by external software. Before each execution, the system verifies that the correct model version is present by comparing a cryptographic model fingerprint and checking a hardware-anchored monotonic counter that prevents rollback to earlier versions. If a mismatch or rollback attempt occurs, execution is halted and the event is recorded. For each decision, the system produces a signed provenance token containing seven fields: a model hash, an input hash, a decision hash, an enclave measurement, a hardware timestamp, a version counter value, and an attestation signature covering all preceding fields. The token enables independent verification of the decision without revealing underlying data. Optional extensions include fairness evaluation, selective encryption, distributed fallback execution, post-quantum signatures, and automated compliance package generation.

### FIELD OF THE INVENTION

This invention relates to generating verifiable proof records for decisions made by artificial intelligence models. More specifically, it relates to running AI models inside protected hardware environments, creating a signed proof record called a provenance token for every decision, and preventing unauthorized substitution of older model versions—enabling any independent party to confirm, long after the fact, exactly which model produced a given decision and that the record has not been altered.

### BACKGROUND OF THE INVENTION

Organizations use artificial intelligence models to assist with important decisions. These models run on ordinary computer servers where anyone with administrative access can change the software, alter the records of what happened, or substitute an older version of the model without detection. There is currently no reliable technical way for an outside party to confirm that a specific AI model produced a specific decision, or that the record of that decision has not been altered after the fact.

This is a technical problem, not merely an organizational one. Software-based logs can be edited or deleted by the people who control the servers. There is no hardware-enforced mechanism in conventional systems that binds a specific decision to the exact model that produced it in a way that cannot be changed after the decision was made.

What is needed is a system that generates proof records inside tamper-resistant hardware, binds each proof record to the specific model that ran, prevents rollback to older model versions, and allows any independent party to verify the records without seeing the underlying private data.

### STATEMENT OF TECHNICAL IMPROVEMENT

The disclosed system improves on conventional AI decision logging in three specific ways. First, proof records are generated inside a hardware-isolated processor enclave where external software cannot interfere, making the records resistant to after-the-fact alteration in a way that software logging cannot achieve. Second, a hardware counter that can only move forward prevents anyone from substituting an older model version, because any such attempt produces a counter value that is lower than the authorized minimum and is immediately detected. Third, each proof record is cryptographically bound to the hardware identity of the enclave that produced it, meaning any independent party can confirm the record is genuine without needing access to the original system. These three improvements are rooted in the physical properties of the hardware, not in software policies that can be overridden.

The prior art problem: AI decision logs stored on ordinary servers can be altered by anyone with administrative access. There is currently no mechanism that makes such alteration computationally infeasible. The technical improvement: provenance tokens in this system are generated inside a hardware-isolated enclave and are cryptographically bound to the enclave measurement. Altering a provenance token after the fact requires the enclave private key, which never leaves the hardware. This makes falsification of the record computationally infeasible without physical access to the processor.

### SUMMARY OF THE INVENTION

The invention is a system for generating attested decision provenance records for AI models. Its four core components are: (1) a protected hardware enclave where the AI model runs in isolation; (2) a verification step that confirms the correct model version is present before each execution; (3) a hardware counter that enforces version progression and detects rollback attempts; and (4) a provenance token generator that produces a signed proof record for every decision. The provenance token is the central artifact of the invention. It contains seven specific fields that together prove which model ran, on what inputs, at what time, inside what hardware environment, and under what version state.

Optional extensions include fairness testing of model outputs, selective encryption to reduce processing overhead, a distributed fallback mode for when the hardware enclave is unavailable, post-quantum signatures for long-term verifiability, and a verification interface for independent auditors. These extensions are described in the dependent claims and do not alter the core invention.

### The Provenance Token

The provenance token is a cryptographically signed data structure produced inside the hardware enclave for every AI decision, as illustrated in FIG. 4. It contains exactly seven fields:
Field 1—Model Hash (see FIG. 4A): a cryptographic fingerprint of the AI model binary and parameters that ran, uniquely identifying the exact version of the model.
Field 2—Input Hash (see FIG. 4B): a cryptographic fingerprint of the input data submitted for the decision, identifying the inputs without revealing their content.
Field 3—Decision Hash (see FIG. 4B): a cryptographic fingerprint of the output or decision produced by the model.
Field 4—Enclave Measurement (see FIG. 4C): a hardware-generated identifier confirming that execution occurred inside an approved protected hardware environment.
Field 5—Timestamp (see FIG. 4D): the time of the decision, recorded from a hardware clock inside the enclave.
Field 6—Version Counter (see FIG. 4D): the current value of the hardware-anchored monotonic counter at the time of the decision, confirming the model version state.
Field 7—Attestation Signature (see FIG. 4E): a cryptographic signature produced by the hardware enclave confirming that all six preceding fields are genuine and were produced inside an approved execution environment.

The token is the minimal sufficient record for independent verification of a decision. A verifier who receives a token can confirm: which model ran (Field 1), what inputs were provided (Field 2), what decision was reached (Field 3), that execution happened inside approved hardware (Field 4), when it happened (Field 5), that the model version was authorized at that time (Field 6), and that none of Fields 1 through 6 have been altered since the token was produced (Field 7).

Each provenance token contains exactly seven named fields: (1) a model hash identifying the AI model that ran; (2) an input hash identifying the inputs provided; (3) a decision hash identifying the output produced; (4) an enclave measurement confirming the hardware environment; (5) a timestamp from the hardware clock inside the enclave; (6) a version counter recording the hardware-anchored monotonic counter value; and (7) an attestation signature produced by the hardware enclave covering all six preceding fields. Each field is described individually in paragraphs [0009] through [0015] and illustrated in FIG. 4A through FIG. 4E.

### Definitions

The following terms are used throughout this application with the meanings set forth below, listed in alphabetical order.

“AI Model” means a computational system trained on data to produce predictions, scores, classifications, or decisions in response to input.

“Attestation” means a hardware-generated cryptographic certificate confirming that a specific AI model ran inside an approved protected hardware environment at a specific point in time.

“Audit Chain” means a permanent, append-only log in which each entry is linked to the one before it using a cryptographic fingerprint, making any modification to any entry detectable by any party inspecting the chain.

“Enclave” means a hardware-enforced isolated processing zone inside a computer processor where software and data are protected from access by any external program, including the operating system and administrative tools.

“Enclave Measurement” means the hardware-generated identifier for a specific enclave configuration, produced by the processor hardware and used to confirm that a given enclave is genuine and unmodified.

“Model Fingerprint” means a unique cryptographic identifier derived from a specific version of an AI model's code and parameters, used to confirm that the exact authorized model is present before execution.

“Monotonic Counter” means a hardware-protected number stored inside the processor that is designed to enforce strictly increasing values and that advances with each new authorized model version. It is not reversible through software instructions. When bound to TPM Platform Configuration Register values, any change to the platform firmware causes the binding to reflect that change, making firmware-level substitution attempts detectable.

“Provenance Token” means a cryptographically signed data structure containing the seven fields defined in paragraphs [0009] through [0015], produced inside the hardware enclave for every AI decision.

“Rollback Attack” means an unauthorized attempt to use an older, previously authorized version of an AI model in place of the current approved version.

“Signed Rollback Event” means a permanent record created when a rollback attempt is detected, containing the rejected version identifier, the counter value that was presented, and the current authorized counter value, signed by the hardware enclave's attestation key.

“Trusted Execution Environment” or “TEE” means a hardware-enforced isolated processing zone inside a computer processor that protects AI model code, parameters, and data from any external software during execution, implemented using processor hardware including Intel Software Guard Extensions, AMD Secure Encrypted Virtualization-Secure Nested Paging, ARM TrustZone, or AWS Nitro Enclaves.

“Version Control Engine” means a system component that records every AI model update in the audit chain, including the previous and new model fingerprints, the date of the update, and the updated counter value.

### BRIEF DESCRIPTION OF THE DRAWINGS

FIG. 1 illustrates the system architecture overview. FIG. 1A illustrates the hardware enclave. FIG. 1B illustrates the model verification step. FIG. 1C illustrates the provenance token generator. FIG. 1D illustrates the audit chain. FIG. 1E illustrates the verification interface.

FIG. 2 illustrates the decision provenance pipeline. FIG. 2A illustrates data ingestion. FIG. 2B illustrates preprocessing. FIG. 2C illustrates enclave execution. FIG. 2D illustrates token generation. FIG. 2E illustrates audit chain recording.

FIG. 3 illustrates the rollback prevention mechanism. FIG. 3A illustrates the hardware counter. FIG. 3B illustrates the model fingerprint registry. FIG. 3C illustrates rollback detection. FIG. 3D illustrates the signed rollback event. FIG. 3E illustrates version transition recording.

FIG. 4 illustrates the provenance token structure. FIG. 4A illustrates Field 1 (model hash). FIG. 4B illustrates Field 2 (input hash) and Field 3 (decision hash). FIG. 4C illustrates Field 4 (enclave measurement). FIG. 4D illustrates Field 5 (timestamp) and Field 6 (version counter). FIG. 4E illustrates Field 7 (attestation signature) and token verification.

FIG. 5 illustrates optional extensions. FIG. 5A illustrates selective encryption. FIG. 5B illustrates fairness testing. FIG. 5C illustrates distributed fallback mode. FIG. 5D illustrates post-quantum signatures. FIG. 5E illustrates the compliance package output.

### DETAILED DESCRIPTION OF THE INVENTION

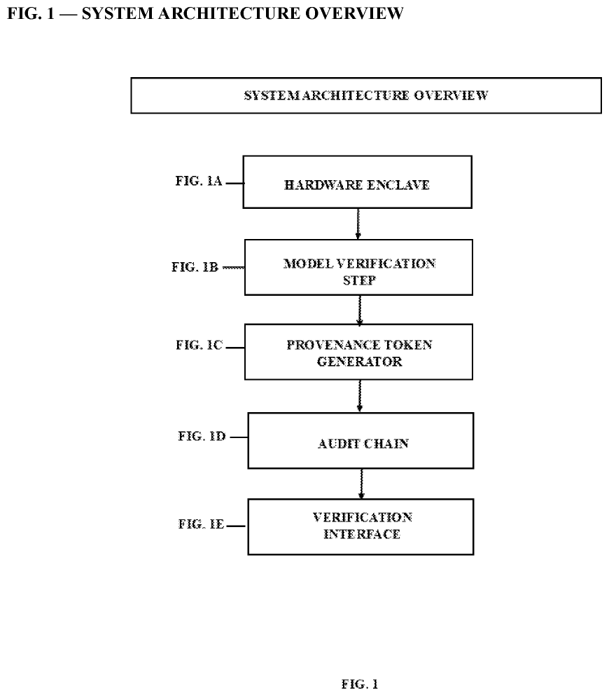

### FIG. 1—System Architecture Overview

FIG. 1 shows the four core components of the system and how they connect. The hardware enclave sits at the center, receiving the AI model and input data and producing outputs together with provenance tokens. The model verification step runs before every execution to confirm the correct authorized model is present. The audit chain stores every provenance token in a permanent linked record. The verification interface allows independent parties to check records without accessing private data.

### FIG. 1A—Hardware Enclave

FIG. 1A shows the hardware enclave where the AI model runs. The enclave is a region inside the computer processor that is isolated from all external software by the hardware itself, not by software controls. No program outside the enclave—including the operating system, cloud management software, or administrator tools—can read or change what is happening inside the enclave while it is running. The enclave is the foundation of the invention: because it is hardware-enforced, the proof records it generates are not falsifiable through software controls alone, including by anyone with administrative access to the server.

### FIG. 1B—Model Verification Step

FIG. 1B shows the verification step that runs before every model execution. The system computes a fingerprint of the model about to run and compares it to the approved fingerprint stored in the registry; if they do not match, execution is blocked and a signed rollback event is recorded. The system also checks the hardware counter to confirm the model version is current; if the counter value is below the authorized minimum, execution is blocked and the attempt is recorded. Both checks together ensure that only the exact authorized model version can run.

### FIG. 1C—Provenance Token Generator

FIG. 1C shows the provenance token generator, which runs inside the hardware enclave immediately after each model execution. The generator assembles the seven fields defined in paragraphs [0009] through [0015] and applies the enclave's attestation signature to the complete record. The signed token is then passed out of the enclave to the audit chain; once it leaves the enclave, the token cannot be altered without invalidating the signature.

### FIG. 1D—Audit Chain

FIG. 1D shows the audit chain that stores every provenance token in a permanent linked record. Each entry in the chain contains the provenance token and a cryptographic link to the previous entry, so that removing or changing any entry breaks the chain and is immediately detectable. The audit chain can be replicated to locations operated by independent parties, making the record available for verification long after the original decision was made.

### FIG. 1E—Verification Interface

FIG. 1E shows the verification interface through which independent parties access the audit chain records. A verifier connects to this interface and can retrieve provenance tokens, confirm attestation signatures, check that the hardware counter has only moved forward, and review any rollback event records. The interface is designed so that all of this can happen without the verifier seeing the underlying private input data that was used in the original decisions.

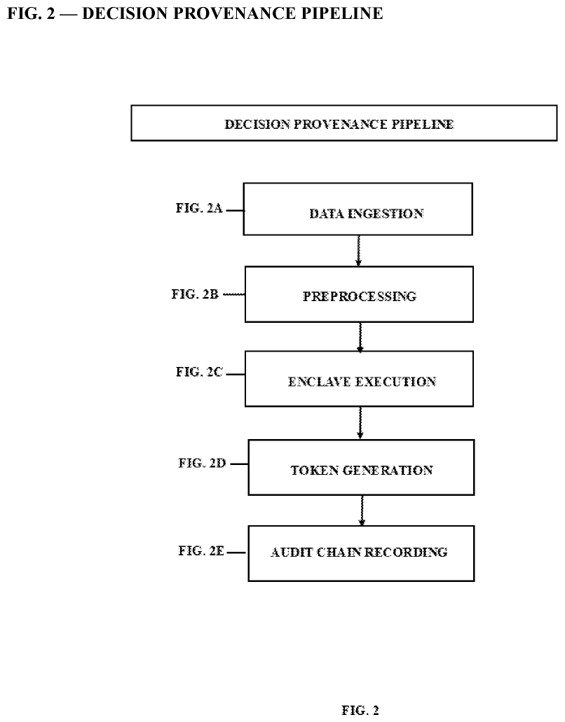

### FIG. 2—Decision Provenance Pipeline

FIG. 2 shows the five steps the system follows each time an AI model produces a decision. These steps proceed in order and each produces a specific output that feeds the next step. At the end of the five steps, a permanent, independently verifiable proof record exists for the decision.

### FIG. 2A—Data Ingestion

FIG. 2A shows the first step, in which input data is received and classified. Each input field is assigned a classification of either sensitive or non-sensitive based on whether it contains protected personal information or proprietary model parameters. This classification determines which fields go directly into the enclave and which can be processed outside first.

### FIG. 2B—Preprocessing

FIG. 2B shows the second step, in which non-sensitive fields are prepared outside the enclave. Routine formatting, normalization, and encoding operations happen here without encryption overhead. Only sensitive fields—those classified in Step 1 as requiring protection—bypass this stage entirely and enter the enclave directly.

### FIG. 2C—Enclave Execution

FIG. 2C shows the third step, in which the AI model runs inside the hardware enclave. Before the model processes any inputs, the model verification step confirms the fingerprint and counter state. The model then processes the inputs and produces an output entirely inside the protected zone; the output is held inside the enclave until the provenance token is generated in the next step.

### FIG. 2D—Token Generation

FIG. 2D shows the fourth step, in which the provenance token is assembled and signed inside the enclave. All seven fields are gathered from the current execution—the model hash, input hash, decision hash, enclave measurement, timestamp, version counter, and attestation signature. The completed token is signed by the enclave's attestation key and is then ready to leave the enclave.

### FIG. 2E—Audit Chain Recording

FIG. 2E shows the fifth step, in which the signed provenance token is appended to the audit chain. The chain creates a new entry linking this token to the previous entry through a cryptographic fingerprint of the prior entry's complete content. Once appended, neither the token nor the chain entry can be altered without breaking the link, and the alteration would be visible to any party inspecting the chain.

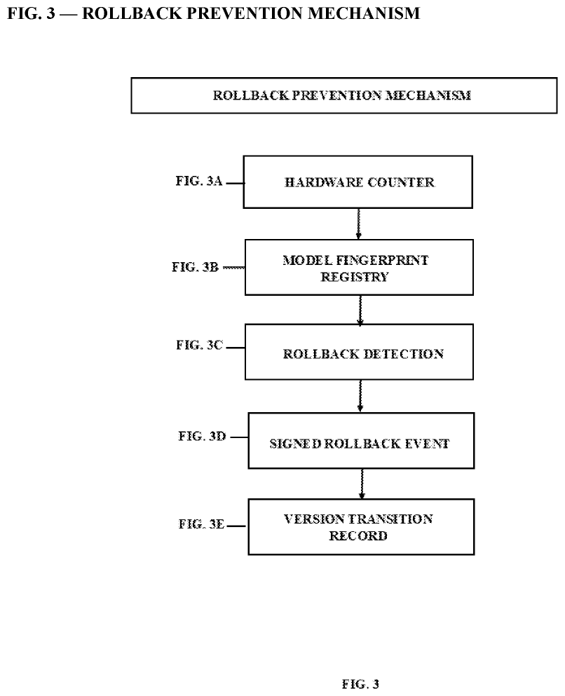

### FIG. 3—Rollback Prevention Mechanism

FIG. 3 shows how the system prevents unauthorized substitution of older AI model versions. The hardware counter, the fingerprint registry, and the rollback detection logic work together at the start of every execution. Any attempt to run an older model version fails both the fingerprint check and the counter check, is blocked before execution begins, and is permanently recorded.

### FIG. 3A—Hardware Counter

FIG. 3A shows the hardware counter that enforces model version progression. The counter is stored inside the processor hardware and is incremented each time a new model version is authorized; it is designed so that software instructions cannot reduce its value. Because the counter lives inside the hardware, it is not accessible to or manipulable by anyone with administrative access to the server operating system or the applications running on it.

### FIG. 3B—Model Fingerprint Registry

FIG. 3B shows the registry that stores the approved fingerprint and minimum counter value for each authorized model version. When a new model version is authorized, the system records its fingerprint and the current counter value as the new minimum for that model. Every execution is checked against these values before the model is allowed to run.

### FIG. 3C—Rollback Detection

FIG. 3C shows the two checks that run at the start of every execution. The first check computes the fingerprint of the model about to run and compares it to the registry; a mismatch means the wrong model is present. The second check reads the hardware counter and compares it to the registered minimum for the claimed model version; a value that is too low means an older version is being presented. If either check fails, execution is blocked immediately.

### FIG. 3D—Signed Rollback Event

FIG. 3D shows the signed rollback event that is created whenever either check in FIG. 3C fails. The event is a permanent record containing: the identifier of the model version that was rejected, the counter value that was presented, and the current authorized counter value. The event is signed by the enclave's attestation key so it cannot be altered or deleted after it is created, and it is appended to the audit chain.

### FIG. 3E—Version Transition Record

FIG. 3E shows the record created each time a new model version is authorized. This record contains the previous model fingerprint, the new model fingerprint, the date of the transition, and the updated counter value. An auditor reviewing the audit chain can use these records to reconstruct the complete history of which model version was in use at any point in time.

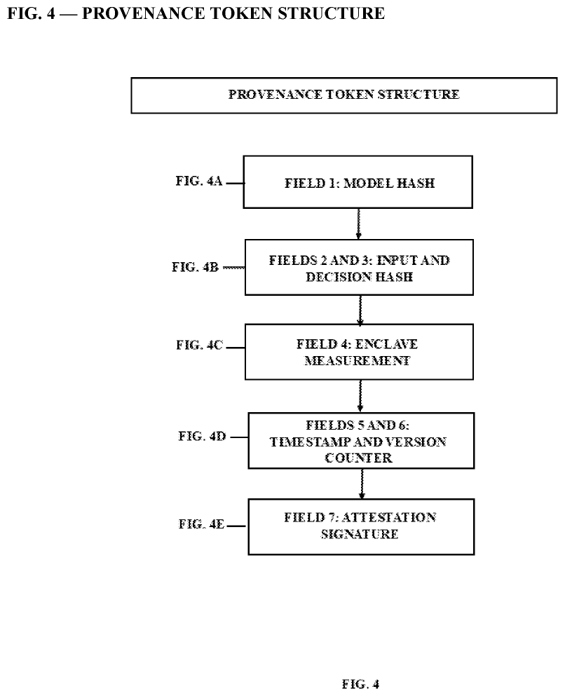

### FIG. 4—Provenance Token Structure

FIG. 4 shows the internal structure of the provenance token in detail. Each subfigure illustrates one or two of the seven fields, explaining what each field contains, why it is needed, and how a verifier uses it. Together the seven fields give a verifier complete confidence in the authenticity and integrity of a decision record without requiring access to any private data.

### FIG. 4A—Field 1: Model Hash

FIG. 4A shows Field 1, the model hash. This field contains the cryptographic fingerprint of the AI model binary and parameter set that ran during this execution. A verifier who wants to confirm which model version produced a given decision compares this hash to the fingerprint registry. If the hashes match, the verifier has confirmed the exact model version responsible for the decision.

### FIG. 4B—Fields 2 and 3: Input and Decision Hash

FIG. 4B shows Field 2 (input hash) and Field 3 (decision hash). The input hash is a fingerprint of the data that was submitted for the decision; it allows verification that the recorded inputs correspond to the actual inputs used, without revealing what those inputs were. The decision hash is a fingerprint of the output the model produced; it confirms that the recorded decision matches what the model actually returned. Together these two fields make it computationally infeasible to claim the decision was based on different inputs or produced a different output, as any such claim would require forging a hash value protected by the attestation signature.

### FIG. 4C—Field 4: Enclave Measurement

FIG. 4C shows Field 4, the enclave measurement. This field contains the hardware-generated identifier of the specific enclave configuration in which the model ran. A verifier can compare this measurement to a known list of approved enclave configurations to confirm that the decision was produced inside genuine, unmodified protected hardware. This field is what distinguishes attested provenance from ordinary software logs: it is generated by the processor hardware and cannot be fabricated by software.

### FIG. 4D—Fields 5 and 6: Timestamp and Version Counter

FIG. 4D shows Field 5 (timestamp) and Field 6 (version counter). The timestamp is recorded from a clock inside the enclave, so it reflects the actual time of execution rather than a time that could be adjusted by server administrators. The version counter records the value of the hardware counter at the time of the decision, allowing a verifier to confirm that an authorized model version was in use and that no rollback had occurred at that point. These two fields together establish when the decision was made and under what version state.

### FIG. 4E—Field 7: Attestation Signature and Token Verification

FIG. 4E shows Field 7, the attestation signature, and the verification process. The attestation signature is produced by the enclave's private signing key, which never leaves the hardware; it covers all six preceding fields as a single unit. A verifier who holds the corresponding public key can confirm that all six fields are authentic and that none has been changed since the token was produced. This single-signature design means that altering any field of the token breaks the signature, giving the token its property as a tamper-evident proof record that is not alterable through software means.

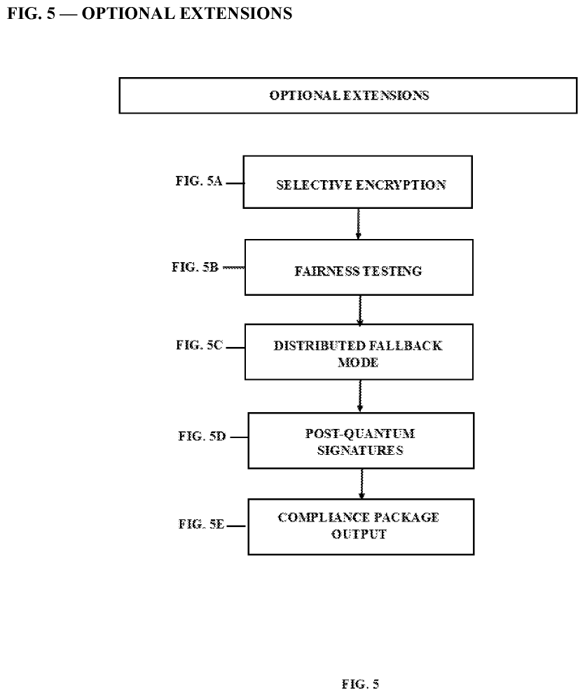

### FIG. 5—Optional Extensions

FIG. 5 shows five optional extensions to the core system. Each extension can be added independently without changing the core provenance token architecture. The core invention described in FIG. 1 through FIG. 4 operates fully without any of these extensions.

### FIG. 5A—Selective Encryption

FIG. 5A shows the optional selective encryption extension. When enabled, only sensitive inputs—model parameters and protected personal data—are encrypted inside the enclave, while non-sensitive preprocessing runs outside without encryption. This reduces the processing overhead compared to encrypting everything, without reducing the protection for the data that actually needs it. The selective encryption boundary is enforced at the hardware level inside the enclave.

### FIG. 5B—Fairness Testing

FIG. 5B shows the optional fairness testing extension. When enabled, after each decision the system compares the model's output against a set of representative profiles from different demographic groups and records whether any group received a meaningfully different outcome. The fairness test results are added to the audit chain entry for that decision. The fairness component is fully optional and can be configured without modifying the AI model itself.

### FIG. 5C—Distributed Fallback Mode

FIG. 5C shows the optional distributed fallback mode. When the hardware enclave is temporarily unavailable, the system can spread model processing across at least three independent computers using a majority-vote rule: a result is only accepted if most computers agree. A sequence counter enforces the same version protection as the hardware counter in normal mode. Provenance tokens generated in fallback mode include a flag indicating that fallback was used.

### FIG. 5D—Post-Quantum Signatures

FIG. 5D shows the optional post-quantum signature support. When enabled, the attestation signature in Field 7 of the provenance token is produced using a signature scheme designed to remain secure against future computing threats. Standard digital signatures used today may become vulnerable over time; post-quantum schemes are built on different mathematics that are expected to remain secure. The system supports the signature standards currently being finalized by the U.S. National Institute of Standards and Technology.

### FIG. 5E—Compliance Package Output

FIG. 5E shows the optional compliance package output. When enabled, the system can assemble a collection of provenance tokens, rollback event records, version transition records, and fairness test results covering a specified time period and format them for delivery to an independent auditor or regulatory authority. The package is self-contained and can be verified by the recipient without any further access to the organization's systems.

### ENABLEMENT EXAMPLES

### Example 1—Bank Loan Decision Audit

A bank uses this system to generate attested proof records for its AI-assisted loan review process. When a loan application is evaluated, the AI model runs inside the hardware enclave and a provenance token is created containing all seven fields. The token is appended to the audit chain and the loan decision is recorded with a reference to that token.

Two years later, a borrower disputes a loan denial, claiming the decision was based on incorrect inputs. The bank produces the provenance token for that specific decision. The token's input hash (Field 2) allows an independent auditor to confirm that the recorded inputs match what was actually submitted, without revealing the borrower's private financial data. The model hash (Field 1) confirms which version of the model was used. The enclave measurement (Field 4) confirms the decision was produced inside genuine hardware.

The bank also demonstrates that no rollback attack occurred during the relevant period by showing the audit chain's rollback event log is empty for that time window. The auditor verifies the attestation signature (Field 7) and confirms the token is genuine. The entire verification process takes minutes and requires no access to the bank's internal systems.

### Example 2—AI Medical Diagnosis Traceability

A hospital uses this system to track AI-assisted diagnostic decisions. Each time an AI model evaluates a medical image and produces a finding, a provenance token is generated inside the enclave. The token records the model fingerprint, the input hash representing the image submitted, the decision hash representing the finding produced, the enclave measurement, the timestamp, and the version counter value.

One year later, a new version of the diagnostic model is deployed. The hardware counter advances, and the old version can no longer run. A physician reviewing a case from the prior year can retrieve the provenance token for that case from the audit chain and confirm exactly which model version produced the original finding. The version transition record in the audit chain shows the exact date the model was updated and what the new fingerprint is.

A regulatory inspection requires the hospital to demonstrate that a specific diagnostic model was in use during a particular period and that no unauthorized changes were made during that time. The hospital provides the relevant provenance tokens and the rollback event log for the period. The inspector verifies the records through the verification interface and completes the review without accessing any patient records.

### Example 3—Autonomous Agent Action Verification

A company deploys an AI agent that takes automated actions on behalf of users. Each action the agent takes—sending a message, approving a transaction, making a scheduling decision—generates a provenance token inside the enclave. The token records which agent model ran, a representation of the context that prompted the action, the action decision itself, the hardware attestation, the timestamp, and the version counter.

A user later claims the agent took an action they did not authorize. The company retrieves the provenance token for that action from the audit chain. The token's decision hash (Field 3) confirms exactly what action was taken. The timestamp (Field 5) confirms when it happened. The enclave measurement (Field 4) confirms the action was taken by an authorized agent running in genuine hardware, not by a modified or substituted version.

The user's own verification system can check the attestation signature (Field 7) to confirm the token is genuine and has not been altered since it was created. If the optional fairness testing extension is enabled, the audit chain entry also shows whether the agent's action would have been different for a user from a different demographic group. All verification is done without exposing any other user's private data.

What is claimed is:

1. A system for generating attested decision provenance records for artificial intelligence models used in regulated domains selected from the group consisting of automated risk classification, insurance claim review, lending decisions, and fraud detection, comprising:
a hardware enclave implemented in hardware-isolated processor circuitry configured to execute an artificial intelligence model in isolation from all external software including the operating system;
a model verification engine configured to confirm, before each execution, that the model's cryptographic fingerprint matches an approved fingerprint in a registry and that the hardware counter value meets or exceeds the authorized minimum for that model version, and upon detecting a mismatch or a counter value that is too low, to halt execution and record a signed rollback event in a permanent audit chain; and
a provenance token generator configured to produce, inside the hardware enclave for each model execution, a signed provenance token containing: a model hash identifying the exact model that ran; an input hash identifying the inputs provided; a decision hash identifying the output produced; an enclave measurement confirming execution in approved hardware; a timestamp from inside the hardware enclave; a version counter value from the hardware-anchored monotonic counter; and an attestation signature produced by the hardware enclave covering all six preceding fields.

2. A method for generating attested decision provenance records for artificial intelligence models used in regulated domains selected from the group consisting of automated risk classification, insurance claim review, lending decisions, and fraud detection, comprising:
executing an artificial intelligence model inside a hardware enclave implemented in hardware-isolated processor circuitry that prevents any external software from accessing model code, parameters, or runtime data;
before each execution, verifying that the model's cryptographic fingerprint matches an approved registry entry and that the hardware counter value is current, and upon detecting any discrepancy, halting execution and recording a signed rollback event in a permanent audit chain; and
generating, inside the hardware enclave for each execution, a signed provenance token containing a model hash, an input hash, a decision hash, an enclave measurement, a hardware timestamp, a version counter value, and an attestation signature covering all six preceding fields.

3. A non-transitory computer-readable medium storing instructions that, when executed by processors operating inside a hardware enclave implemented in hardware-isolated processor circuitry, cause the processors to:
execute an artificial intelligence model in isolation from all software outside the hardware enclave;
before each execution, verify the model's cryptographic fingerprint against an approved registry and confirm the hardware counter value is current, and upon detecting any mismatch or rollback attempt, halt execution and record a signed rollback event in the permanent audit chain; and
generate, for each execution, a signed provenance token containing a model hash, an input hash, a decision hash, an enclave measurement, a hardware timestamp, a version counter value, and an attestation signature covering all preceding fields.

4. The system of claim 1, wherein the hardware enclave is implemented using processor hardware selected from the group consisting of Intel Software Guard Extensions, AMD Secure Encrypted Virtualization-Secure Nested Paging, ARM TrustZone, and AWS Nitro Enclaves.

5. The system of claim 1, wherein the hardware-anchored monotonic counter is bound to platform firmware measurements stored in TPM Platform Configuration Registers, such that any modification to firmware configuration causes the counter binding to reflect the change, making firmware substitution attempts detectable.

6. The system of claim 1, further comprising a permanent audit chain that stores provenance tokens in an append-only structure in which each entry includes a cryptographic link to the previous entry, such that any modification to any entry is detectable by any party inspecting the chain, and wherein the audit chain may be replicated to locations operated by independent parties.

7. The system of claim 1, further comprising a version control engine that records every model update in the permanent audit chain including the previous and new model fingerprints, the date of the update, and the updated counter value, enabling any party to reconstruct the complete history of model versions.

8. The system of claim 1, further comprising a verification interface that allows independent parties to retrieve and confirm provenance tokens, version counter continuity, and rollback event records without accessing the underlying private data used in the original decisions.

9. The system of claim 1, further comprising a selective encryption component that encrypts only sensitive inputs—including model parameters and protected personal data—inside the hardware enclave, while allowing non-sensitive preprocessing to occur outside, maintaining protection for sensitive data while reducing processing overhead compared to full encryption.

10. The system of claim 1, further comprising a fairness validation component that tests the model's outputs against a set of representative demographic profiles, records whether any group received a meaningfully different outcome, and adds the fairness test results to the audit chain entry for that decision, wherein the fairness threshold is configurable without modifying the AI model.

11. The system of claim 10, wherein the fairness test uses a Kolmogorov-Smirnov test or a chi-squared test to detect meaningful differences in outcomes across demographic groups.

12. The system of claim 1, further comprising a distributed fallback mode that, when the hardware enclave is temporarily unavailable, distributes model processing across at least three independent computers under a majority-vote protocol, uses a sequence counter to provide version enforcement equivalent to the hardware counter, and marks provenance tokens generated in fallback mode with an indication that fallback was used.

13. The system of claim 1, wherein the attestation signature in the provenance token is produced using a post-quantum cryptographic signature scheme selected from the group consisting of ML-DSA (NIST FIPS 204), SLH-DSA (NIST FIPS 205), and FN-DSA (forthcoming NIST FIPS 206), preserving verifiability against future computing threats.

14. The system of claim 1, wherein the system processes models used for at least one of: automated risk classification, insurance claim review, lending decisions, or fraud detection, and wherein each provenance token enables independent verification of the decision without disclosing the underlying private data.

15. The system of claim 14, further comprising a compliance package generator that assembles provenance tokens, rollback event records, version transition records, and fairness test results for a specified period into a self-contained package formatted for delivery to independent auditors or regulatory authorities.

16. The system of claim 6, wherein the permanent audit chain is replicated to at least one location operated by an independent third party, enabling verification of governance records without access to the organization's systems.

17. The method of claim 2, further comprising storing each provenance token in a permanent audit chain in which each entry is cryptographically linked to the previous entry, such that any modification is detectable.

18. The method of claim 2, further comprising testing the model's outputs against representative demographic profiles and recording the fairness comparison results in the audit chain for each decision.

19. The non-transitory computer-readable medium of claim 3, wherein the instructions further cause the processors to store provenance tokens in a permanent audit chain in which each entry is cryptographically linked to the previous entry.

20. The system of claim 1, wherein each signed rollback event recorded in the permanent audit chain contains the rejected version identifier, the counter value that was presented, the current authorized counter value, and a forensic timestamp, and is signed by the hardware enclave's attestation key, enabling any independent party to verify the event.
